(19) United States
(12) Patent Application Publication
(10) Pub. No.: US 2025/0020295 A1
(43) Pub. Date: Jan. 16, 2025

(54) EMERGENCY POWER SUPPLY FOR PANEL LAMP

(71) Applicant: Dongguan Haiyue Intelligent Technology Co., Ltd, Dongguan (CN)

(72) Inventors: Huishi Tan, Dongguan (CN); Tan Long, Dongguan (CN)

(21) Appl. No.: 18/527,360

(22) Filed: Dec. 3, 2023

(30) Foreign Application Priority Data
Jul. 10, 2023 (CN) 202321792777.7

(51) Int. Cl. H02J 9/06; F21S 9/02; F21V 17/00; F21V 17/06; F21V 23/00; F21V 23/06

(52) U.S. Cl. CPC F21S 9/022; F21V 17/005; F21V 17/06; F21V 23/004; F21V 23/06

(57) ABSTRACT

Disclosed is an emergency power supply for a panel lamp, including a panel lamp, at least provided with a light board inclined surface and provided with a plurality of buckles on at least one side surface; an emergency power supply, including a power supply body, and at least one power cord, and at least one metal hose. The power supply body is detachably fixed onto the panel lamp, and the power supply body is provided with an inclined surface in fit with the light board inclined surface. The power cord is electrically connected to the power supply body and arranged in the metal hose, and the metal hose is fixedly clamped onto a corresponding buckle.

### CROSS-REFERENCE TO RELATED APPLICATION

The present application claims priority from Chinese Patent Application No. 202321792777.7 filed on Jul. 10, 2023, the contents of which are incorporated herein by reference in their entirety.

### FIELD OF TECHNOLOGY

The present application relates to the technical field of emergency power supplies, and in particular to an emergency power supply for a panel lamp.

### BACKGROUND

LED (Light-emitting diode) panel lamp is a high-grade indoor lighting fitting, with an outer frame made of aluminum alloy by anodic oxidation and an LED as the light source. The whole lamp is beautiful, simple and luxurious in design, which not only has good lighting effect, but also can bring beautiful feelings to people.

However, when the power supply is off, the LED panel lights is not lit, and the room becomes dark, which makes the experience of people worse. Therefore, there is an urgent need of an emergency power supply capable of supplying power to an LED panel lamp when the power supply is off, and the emergency power supply is convenient to assemble and disassemble.

### SUMMARY

For the problems existing in the prior art, the present application provides an emergency power supply for a panel lamp.

To achieve the objective above, the technical solution of the present application is as follows:

An emergency power supply for a panel lamp includes:
a panel lamp, at least provided with a light board inclined surface and provided with multiple buckles on at least one side surface; and
an emergency power supply, including a power supply body, at least one power cord, and at least one metal hose, where the power supply body is detachably fixed onto the panel lamp, the power supply body is provided with an inclined surface in fit with the light board inclined surface, the power cord is electrically connected to the power supply body and arranged in the metal hose, and the metal hose is fixedly clamped onto a corresponding buckle.

Alternatively, a magnet is arranged in each of the multiple buckles.

Alternatively, the power supply body comprises:
an upper cover, detachably fixed onto the panel lamp;
a battery, arranged in the upper cover;
a PCB (Printed Circuit Board), arranged in the upper cover and electrically connected to the battery, where the power cord is electrically connected to the PCB, and a key is further connected to the PCB.

Alternatively, each of both ends of the upper cover is provided with a through hole, the through hole is provided with a connector, and one end of the metal hose is correspondingly arranged on a hose connector.

Alternatively, the connector is also provided with a screw hole and a screw, and the screw is used to fix a corresponding metal hose through the screw hole.

Alternatively, a nut is arranged on a corresponding through hole of the upper cover, and the connector is fixed to the corresponding nut in a threaded manner.

Alternatively, the emergency power supply further includes a lower cover. The lower cover is arranged below the upper cover and fixed by a screw.

Alternatively, each of both ends of the lower cover is also provided with an adjusting mounting hole, and the panel lamp is provided with multiple corresponding positioning screw holes corresponding to the mounting holes.

Alternatively, each of four surfaces of the panel lamp is provided with a light board inclined surface.

Alternatively, a side surface adjacent to the power supply body is provided with multiple buckles.

The technical solution of the present application has the following beneficial effects:

When an external power supply is off, an emergency power supply can be configured to supply power to a panel lamp through a power cord. When the external power supply is in operation, the emergency power supply can be configured charge an internal battery through the power cord for use after the external power supply is off. In this case, the emergency power supply can continuously supply power to the panel lamp after the external power supply of the panel lamp is off. Further, a power supply body is provided with an inclined surface which is in fit with a light board inclined surface, thus making the emergency power supply integrated with the panel lamp. Meanwhile, the power cord is fixed through buckles, such that the emergency power supply can be conveniently assembled and disassembled, and the power cord becomes neat after being installed on the panel lamp. In addition, each of both ends of a lower cover is also provided with an adjusting mounting hole, and the panel lamp is provided with multiple corresponding positioning screw holes corresponding to mounting holes, such that a position of the emergency power supply can be conveniently adjusted through the adjustment of the mounting holes.

### BRIEF DESCRIPTION OF THE DRAWINGS

FIG. 1 is a schematic diagram of an overall structure according to the present application;

FIG. 2 is a schematic diagram of an exploded structure of an emergency power supply according to the present application;

FIG. 3 is a structural schematic diagram of a buckle according to the present application;

FIG. 4 is a partial enlarged diagram of an emergency power supply and a panel lamp according to the present application;

FIG. 5 is a schematic diagram of a partial structure extending from a key to the back of a panel lamp according to the present application;

FIG. 6 is a schematic diagram of another overall structure according to the present application.

### DESCRIPTION OF THE EMBODIMENTS

The embodiments of the present application are described in detail below. Examples of the embodiments are shown in the accompanying drawings, and the same or similar numbers throughout this specification represent the same or similar elements or elements having the same or similar functions. The embodiments described below by referring to the accompanying drawings are exemplary and are intended to explain the present application, but cannot be understood as limitations of the present application.

In the description of the present application, it needs to be understood that the orientation or positional relationship indicated by terms “center”, “longitudinal”, “transverse”, “length”, “width”, “thickness”, “upper”, “lower”, “front”, “back”, “left”, “right”, “vertical”, “horizontal”, “top”, “bottom”, “inside”, “outside”, “clockwise”, “counterclockwise” is based on the orientation or positional relationship shown in the drawings only for convenience of description of the present application and simplification of description rather than indicating or implying that the device or element referred to must have a particular orientation, be constructed and operate in a particular orientation, and thus are not to be construed as limiting the present application.

Furthermore, the terms “first” and “second” are used for descriptive purposes only and are not to be construed as indicating or implying relative importance or implying a number of the indicated technical features. Thus, the feature defined by “first” and “second” can explicitly or implicitly include one or more features. In the description of the present application, “a plurality of” means two or more, unless expressly specified otherwise.

In the present application, unless expressly specified and limited otherwise, the terms “install”, “connect”, “couple”, “fix”, and the like should be understood broadly, e.g., may be either a fixed connection or a detachable connection, or a connection in one piece; may be a mechanical connection or an electrical connection; may be a direct connection or an indirect connection through an intermediate medium, may be an internal communication between the two elements or interactions between the two elements. For those of ordinary skill in the art, the specific meanings of the above terms in the present application can be understood on a case-by-case basis.

In the present application, unless expressly specified and limited otherwise, a first feature “on” or “under” a second feature may refer to that the first feature is in direct contact with the second feature, and may refer to that the first feature is in indirect contact with the second feature by an intermediate medium. Moreover, the first feature is “above”, “on” and “over” the second feature, which includes that the first feature is above and at an inclined top of the second feature, or only indicates that a horizontal height of the first feature is higher than that of the second feature. The first feature is “below”, “under” and “beneath” the second feature, which includes that the first feature is below and at an inclined bottom of the second feature, or only indicates that a horizontal height of the first feature is lower than that of the second feature.

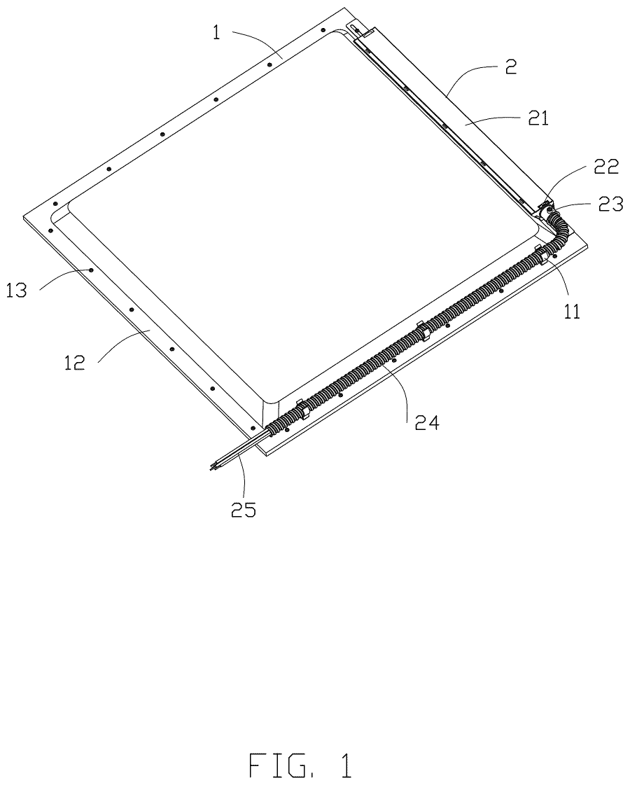

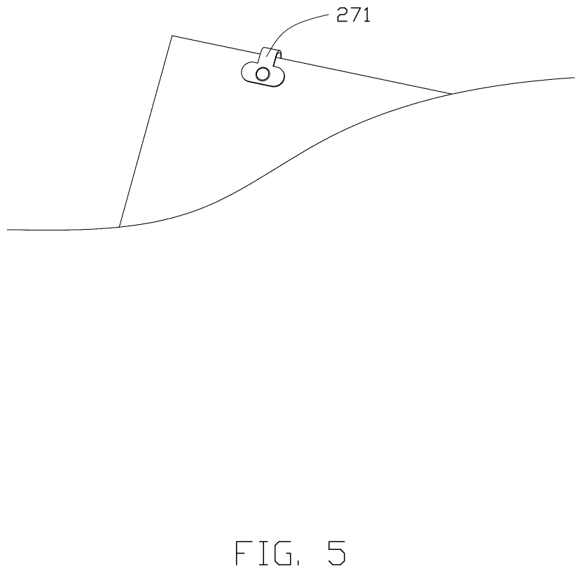

Referring to FIG. 1 through FIG. 6, an emergency power supply for a panel lamp includes:
a panel lamp 1, at least provided with a light board inclined surface 12 and provided with multiple buckles 11 on at least one side surface; and
an emergency power supply 2, including a power supply body, at least one power cord 25, and at least one metal hose 24, where the power supply body is detachably fixed onto the panel lamp 1, the power supply body is provided with an inclined surface in fit with the light board inclined surface 12, the power cord 25 is electrically connected to the power supply body and arranged in the metal hose 24, and the metal hose 24 is fixedly clamped onto a corresponding buckle 11.

Specifically, the emergency power supply 2 may be fixed to one side surface of the panel lamp 1 by a screw or a buckle, and meanwhile, the power cord 25 is also fixed into the buckle 11, thus facilitating the arrangement of the emergency power supply and the power cord 25 and mounting the emergency power supply 2 on the panel lamp 1. Moreover, the power supply body is provided with an inclined surface in fit with the light board inclined surface 12, which makes the emergency power supply 2 integrated with the panel lamp 1. Meanwhile, the power cord 25 does not look messy.

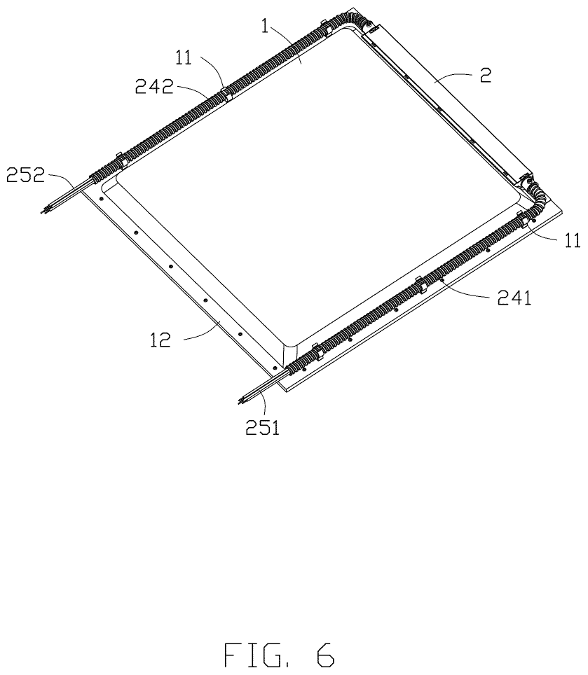

As shown in FIG. 6: further, each of four surfaces of the panel lamp 1 may be provided with a light board inclined surface 12, and an adjacent side surface of the power supply body is provided with multiple buckles 11. The power cord 25 may include a first power cord 251 and a second power cord 252. The metal hose 24 may also be correspondingly provided with a first metal hose 241 and a second metal hose 242. The first power cord 251 is arranged in the first metal hose 241, and the second power cord 252 is arranged in the second metal hose 242. The first metal hose 241 and the second metal hose 242 are respectively clamped onto corresponding buckles 11 along adjacent side surfaces of the power supply body.

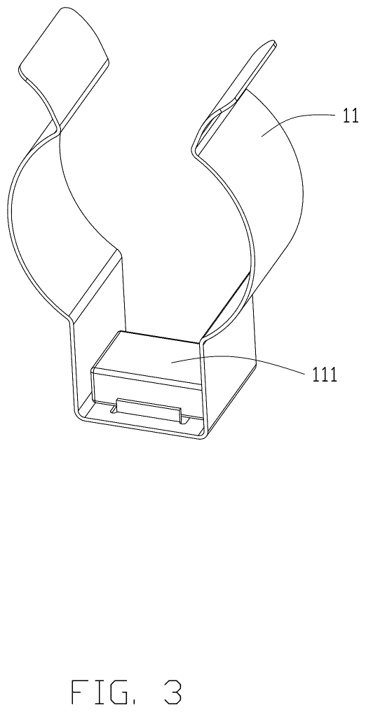

As shown in FIG. 1 and FIG. 3, in this embodiment, a magnet 111 is arranged in each of the multiple buckles 11. Specifically, the buckle 11 is used to fixedly clamp the metal hose 24, and the magnet 111 is used to attract the metal hose 24, such that a situation that the installation is affected as the metal hose 24 moves during installation is avoided.

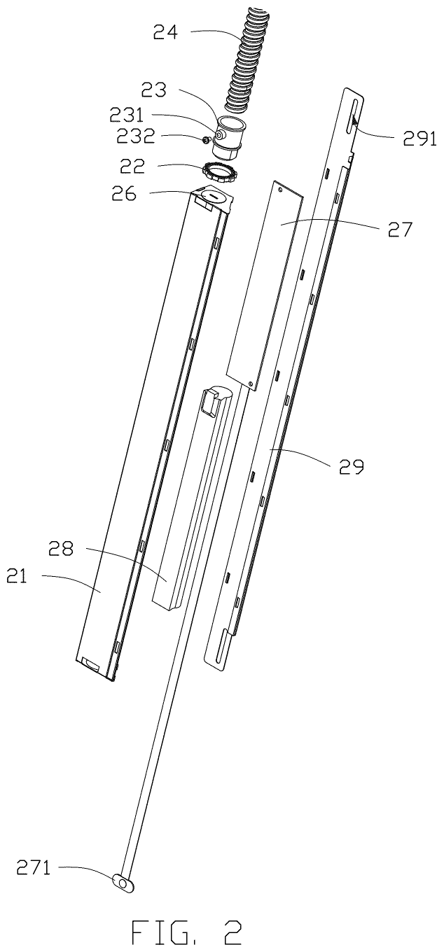

As shown in FIG. 2, in this embodiment, the power supply body includes an upper cover 21, detachably fixed onto the panel lamp 1; a battery 28, arranged in the upper cover 21; and a PCB 27, arranged in the upper cover 21 and electrically connected to the battery 28. The power cord 25 is electrically connected to the PCB 27, and a key 271, which extends to the back of the panel lamp 1, is also connected to the PCB 27.

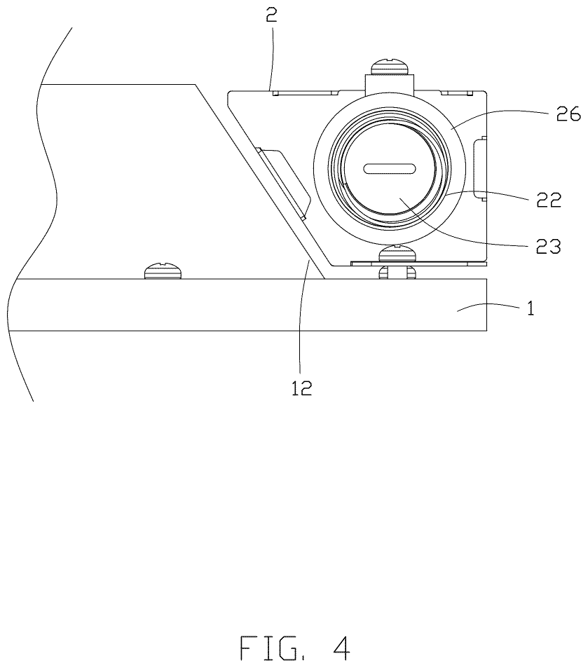

As shown in FIG. 4, each of both ends of the upper cover 21 is provided with a through hole 26, the through hole 26 is also provided with a connector 23, and one end of the metal hose 24 is correspondingly arranged on the hose connector 23. The connector 23 is also provided with a screw hole 231 and a screw 232. The screw 232 is used to fix the corresponding metal hose 24 through the screw hole 231. A nut 22 is arranged on the corresponding through hole 26 of the upper cover 21, and the connector 23 is fixed to the corresponding nut 22 in a threaded manner.

Specifically, a connector 23 is connected into the through hole 26, one end of the power cord 25 is connected to the emergency power supply 2 after penetrating through the connector 23, while one end of the metal hose 24 is fixed to the corresponding connector 23. The tightness of the connector 23 is adjusted by the screw, and the connector 23 is fixed to the through hole 26 of the emergency power supply through the nut 22.

As shown in FIG. 2, in this embodiment, the emergency power supply 2 further includes a lower cover 29, and the lower cover 29 is arranged below the upper cover 21 and fixed by the screw. Each of both ends of the lower cover 29 is also provided with an adjusting mounting hole 291, and the panel lamp 1 is provided with multiple corresponding positioning screw holes 13 corresponding to the mounting holes 291.

Specifically, positions of the emergency power supply 2 and the panel lamp 1 can be adjusted by adjusting positions of the mounting hole and the screw hole 291, and a hole diameter of the mounting hole 291 is greater than that of the positioning screw hole.

The above is only the preferred embodiment of the present application, and does not therefore limit the patent scope of the present application. Any equivalent structural transformation made by using the description and accompanying drawings of the present application, or direct/indirect application in other related technical fields are included in the patent protection scope of the present application.

What is claimed is:

1. An emergency power supply for a panel lamp, comprising:
a panel lamp, at least provided with a light board inclined surface and provided with a plurality of buckles on at least one side surface; and
an emergency power supply, comprising a power supply body, at least one power cord, and at least one metal hose, wherein the power supply body is detachably fixed onto the panel lamp, the power supply body is provided with an inclined surface in fit with the light board inclined surface, the power cord is electrically connected to the power supply body and arranged in the metal hose, and the metal hose is fixedly clamped onto a corresponding buckle.

2. The emergency power supply for a panel lamp according to claim 1, wherein a magnet is arranged in each of the buckles.

3. The emergency power supply for a panel lamp according to claim 1, wherein the power supply body comprises:
an upper cover, detachably fixed onto the panel lamp;
a battery, arranged in the upper cover; and
a PCB (Printed Circuit Board), arranged in the upper cover and electrically connected to the battery, wherein the power cord is electrically connected to the PCB, and a key is connected to the PCB.

4. The emergency power supply for a panel lamp according to claim 2, wherein each of both ends of the upper cover is provided with a through hole, the through hole is provided with a connector, and one end of the metal hose is correspondingly arranged on a hose connector.

5. The emergency power supply for a panel lamp according to claim 4, wherein the connector is provided with a screw hole and a screw, and the screw is used to fix the corresponding metal hose through the screw hole.

6. The emergency power supply for a panel lamp according to claim 5, wherein a nut is arranged on a corresponding through hole of the upper cover, and the connector is fixed to the corresponding nut in a threaded manner.

7. The emergency power supply for a panel lamp according to claim 6, wherein the emergency power supply further comprises a lower cover, and the lower cover is arranged below the upper cover and fixed by a screw.

8. The emergency power supply for a panel lamp according to claim 7, wherein each of both ends of the lower cover is also provided with an adjusting mounting hole, and the panel lamp is provided with a plurality of corresponding positioning screw holes corresponding to the mounting holes.

9. The emergency power supply for a panel lamp according to claim 1, wherein each of four surfaces of the panel lamp is provided with a light board inclined surface.

10. The emergency power supply for a panel lamp according to claim 2, wherein a side surface adjacent to the power supply body is provided with a plurality of buckles.
